(19) United States
(12) Patent Application Publication
(10) Pub. No.: US 2008/0044714 A1
(43) Pub. Date: Feb. 21, 2008

(54) Fuel cell stack

(75) Inventors: Wolfgang Fritz, Metzingen (DE); Uwe Maier, Reutlingen (DE)

Correspondence Address: Mr. Edward J. Timmer, P.O. Box 770, Richland, MI, 49083-0770, US

(73) Assignee: ElringKlinger AG

(21) Appl. No.: 11/787,765

(22) Filed: Apr. 18, 2007

(30) Foreign Application Priority Data
Jun. 21, 2006 (DE) 10 2006 028 440.2

(51) Int. Cl. H01M 8/04

(52) U.S. Cl. 429/37

(57) ABSTRACT

In order to produce a fuel cell stack which comprises several fuel cell units that succeed one another in the direction of the stack, at least one tensioning device by means of which the fuel cell units are braced against each other, and at least one stack end element which forms an end face boundary for the fuel cell stack such that the stack can be assembled in a particularly quick and easy manner, it is proposed that the tensioning device should comprise at least one tensioning element which transmits a tensional force for the tensioning of the fuel cell units and is hooked onto at least one stack end element.

The present disclosure relates to the subject matter disclosed in the German patent application No. 10 2006 028 440.2 dated 21 Jun. 2006. The entire description of this earlier application is incorporated by reference thereto as a constituent part of the present description (“incorporation by reference”).

The present invention relates to a fuel cell stack which comprises a plurality of fuel cell units that succeed one another in the direction of the stack, at least one tensioning device by means of which the fuel cell units are braced against each other, and at least one stack end element which forms an end face boundary for the fuel cell stack.

Such a fuel cell stack is known from DE 100 44 703 A1 for example.

In known fuel cell stacks of this type, the tensioning device comprises a plurality of tie rods and nuts by means of which solid end plates of the fuel cell stack are pulled against one another in order to apply the sealing and contacting forces to the fuel cell units that are required during the operation of the fuel cell stack.

From DE 10 2004 037 678 A1, it is known to implement the tensioning elements by means of which the end plates of a fuel cell stack are braced against each other in the form of a bar, rope, wire, chain, tape or fibre material.

The object of the present invention is to produce a fuel cell stack of the type mentioned hereinabove which is adapted to be assembled in a particularly quick and easy manner.

In accordance with the invention, this object is achieved in the case of a fuel cell stack including the features indicated in the preamble of claim 1 in that the tensioning device comprises at least one tensioning element which transmits a tensional force for the tensioning of the fuel cell units and is hooked onto at least one stack end element.

Due to the fact that in the case of the fuel cell stack in accordance with the invention the tensioning element does not have to be screwed to the stack end element and also does not have to be fixed to the stack end element by some other form of fixing means but rather is adapted to be hooked onto the stack end element without using an additional tool, the process of assembling the fuel cell stack in accordance with the invention and also the disassembly thereof (in the case of maintenance or for repair) is made particularly quick and easy.

It is particularly expedient that the hooked on tensioning element can also be easily released from the stack end element should this be necessary.

The process of hooking the tensioning element on the stack end element can be carried out in a particularly simple manner if the stack end element comprises at least one hooking nose for the purposes of hooking on the tensioning element.

Such a hooking nose may comprise, in particular, a projection forming an under-cut by virtue of which the tensioning element is prevented from being removed from the stack end element.

Furthermore, it is expedient if the tensioning element comprises at least one hooking opening for the purposes of hooking it on the stack end element.

In a special embodiment of the invention, provision is made for the fuel cell stack to comprise two mutually opposed stack end elements which form a respective end face boundary for the fuel cell stack, and for at least one tensioning element to be hooked onto the two stack end elements.

Furthermore, it is expedient if at least one tensioning element is in the form of a strip or tape. A tensioning element in the form of a strip or tape is very light in weight and only needs a small amount of space. Furthermore, such tensioning elements in the form of a strip or tape are easily and rapidly installed and economical to obtain.

Furthermore, provision may advantageously be made for at least one tensioning element to extend around at least one end face of the fuel cell stack. The tensioning forces produced by the tensioning element can thereby be introduced into the fuel cell units via the relevant end face of the fuel cell stack such that they are uniformly distributed over a large surface area, whereby a better distribution of the force is obtained compared with tensioning means which only engage with the edge of the end plates of the fuel cell stack.

The fuel cell stack in accordance with the invention may comprise high temperature fuel cell units (for example of the SOFC (Solid Oxide Fuel Cell) type) or else low temperature fuel cell units (for example of the PEM (Polymer Electrolyte Membrane) type or of the DMFC (Direct Methanol Fuel Cell) type).

The tensioning device in accordance with the invention preferably serves for applying the requisite sealing and contacting forces during operation of the fuel cell stack, but it could merely serve as a means for securing the stack during transportation thereof (in the latter case, the tensioning device can be removed prior to operating the fuel cell stack).

In a preferred embodiment of the invention, provision is made for the tensioning device to comprise at least two tensioning elements which extend around at least one end face of the fuel cell stack and are mutually spaced in a direction running transverse to the direction of the stack.

The fuel cell stack may comprise at least one stack end element which forms an end face boundary for the fuel cell stack.

Such a stack end element can, in particular, be formed as an end plate.

In this case, at least one tensioning element preferably extends around at least one stack end element of the fuel cell stack.

The tensioning element extending around at least one stack end element of the fuel cell stack may be hooked onto another stack end element of the fuel cell stack.

It is expedient hereby, if at least one tensioning element lies on at least one stack end element especially in a substantially flat manner in order to ensure that the tensioning element introduces force into the stack end element in a highly effective manner.

The tensioning element that is used is preferably flexible so that it can adapt itself to a stack end element of any arbitrary shape.

In order to tension the tensioning element, the tensioning element is fixed to at least one stack end element.

In the event of a change in temperature, the fuel cell units on the one hand and the material of the tensioning element on the other hand may expand in the direction of the stack by different amounts due to their differing average coefficients of thermal expansion. In order to provide compensation for such differences in thermal expansion, it is of advantage if the tensioning device comprises at least one resilient longitudinal expansion compensating element.

It is particularly expedient, if the longitudinal expansion compensating element is integrated into at least one tensioning element since the number of components required for the construction of the fuel cell stack can be reduced in this way.

The tensioning element is preferably formed in one piece with the longitudinal expansion compensating element.

In particular, provision may be made for at least one longitudinal expansion compensating element to be formed by a corrugated and/or folded region of at least one tensioning element.

As an alternative or in addition thereto, provision may be made for at least one longitudinal expansion compensating element to be formed by a region of at least one tensioning element that is provided with a deformable recess

In order to enable the flow of force between the fuel cell units on the one hand and the tensioning element on the other to be controlled more precisely and equalised, it is of advantage if the fuel cell stack comprises at least one resilient pressure transmission element.

Such a pressure transmission element may be arranged, in particular, between a fuel cell unit and a stack end element which forms an end face boundary for the fuel cell stack.

In order to enable the fuel cell units to be operated at an operating temperature that is significantly above the ambient temperature especially when using high temperature fuel cell units of the SOFC (Solid Oxide Fuel Cell) type for example, it is of advantage if the fuel cell stack comprises at least one thermal insulation element.

Such a thermal insulation element may be arranged, in particular, between the fuel cell units and at least one tensioning element. In this case, it is not necessary for the tensioning element to be mechanically and chemically stable at the operating temperature of the fuel cell units.

Further features and advantages of the invention form the subject matter of the following description and the pictorial illustration of exemplary embodiments.

In the drawings:

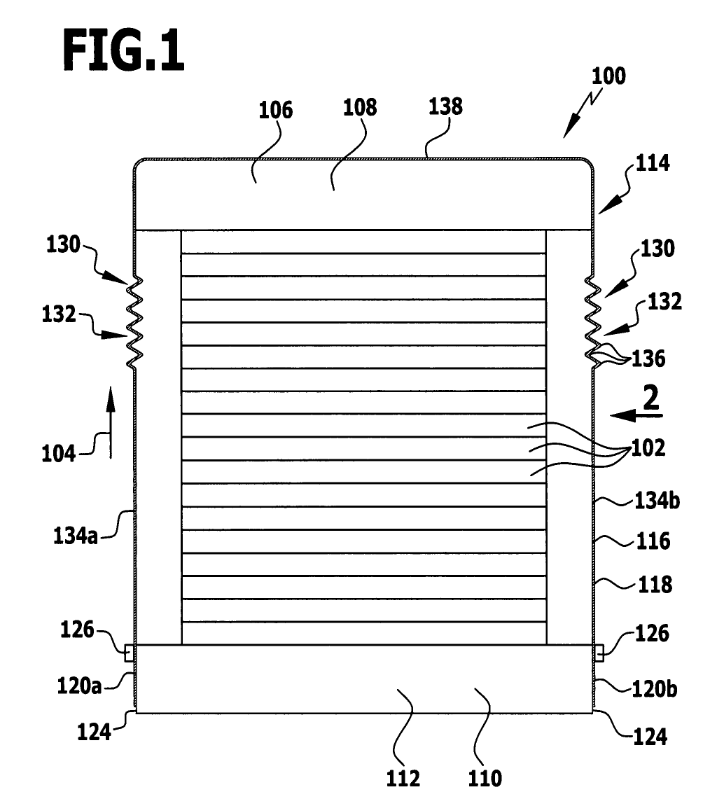

FIG. 1 shows a schematic front view of a fuel cell stack including two end plates and two tensioning tapes which are led around one of the end plates and hooked onto the second end plate;

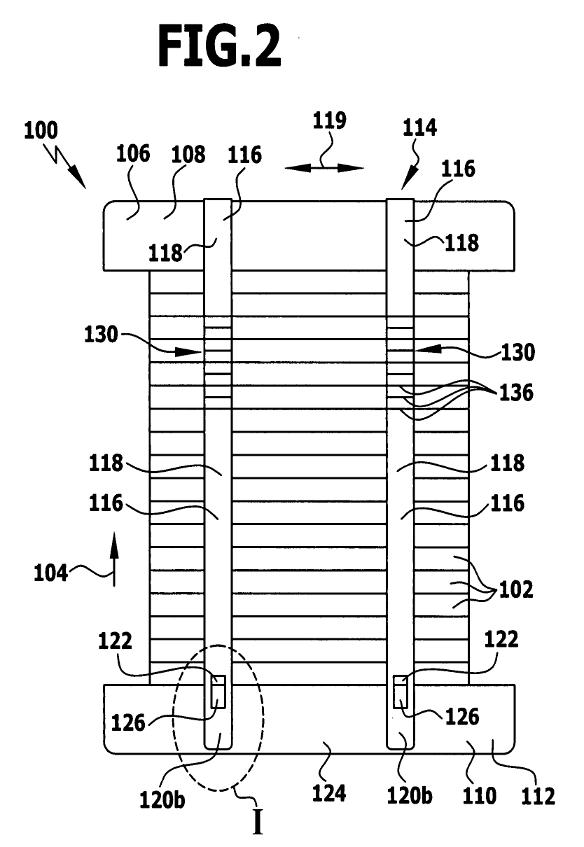

FIG. 2 a schematic side view of the fuel cell stack in FIG. 1 along the line of sight in the direction of the arrow 2 in FIG. 1;

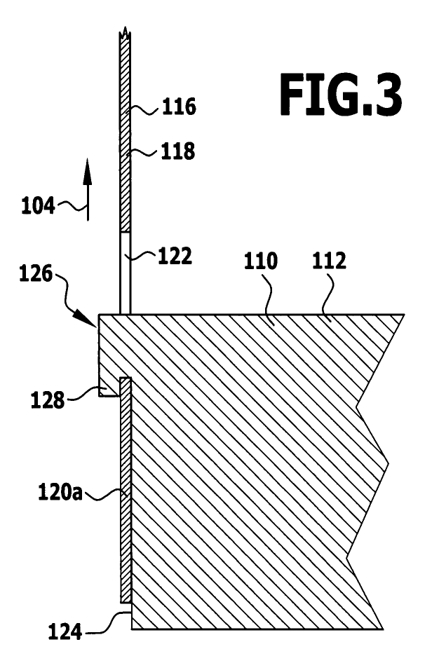

FIG. 3 a schematic vertical section through an edge region of the lower end plate of the fuel cell stack and a tensioning tape hooked thereon;

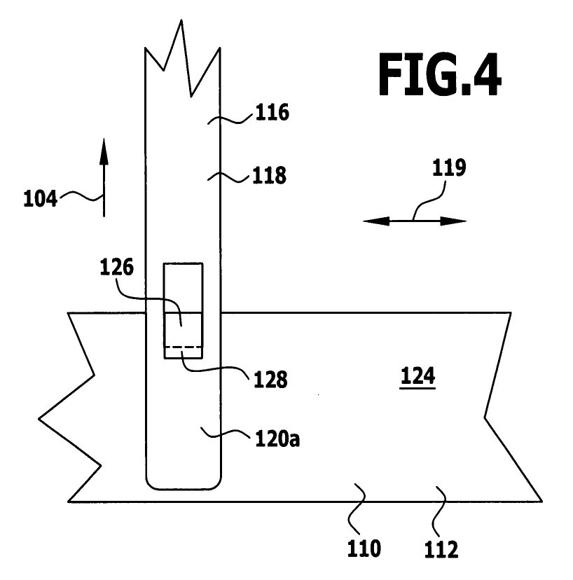

FIG. 4 an enlarged illustration of the region I in FIG. 2;

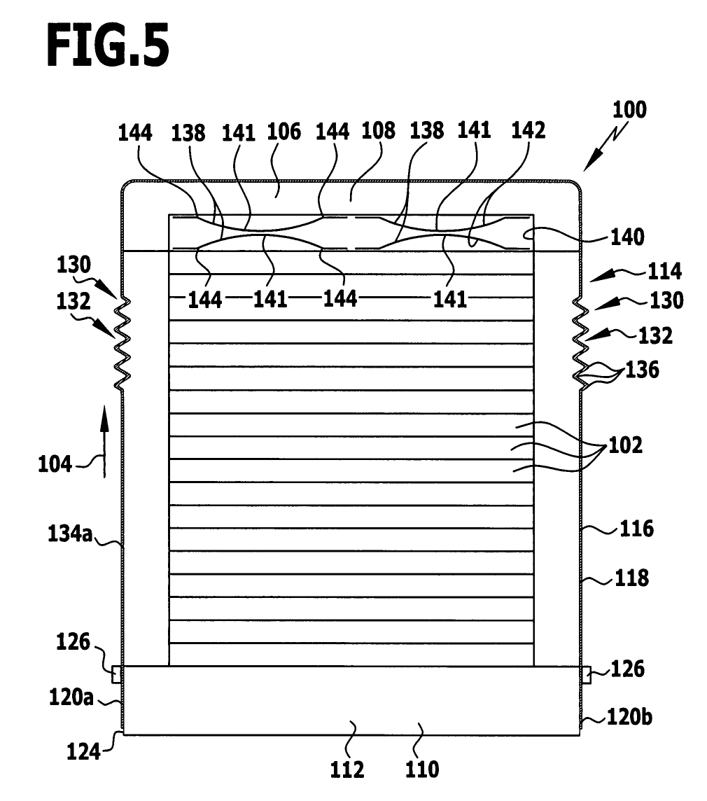

FIG. 5 a schematic front view of a second embodiment of a fuel cell stack which comprises resilient pressure transmission elements arranged between the uppermost fuel cell unit and the upper end plate;

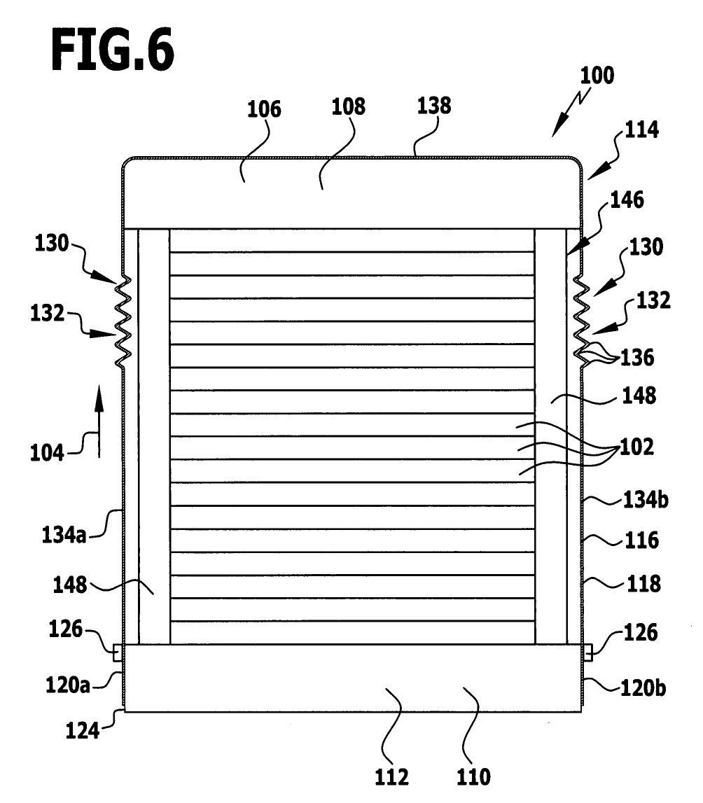

FIG. 6 a schematic front view of a third embodiment of a fuel cell stack which comprises thermal insulation elements surrounding the fuel cell units;

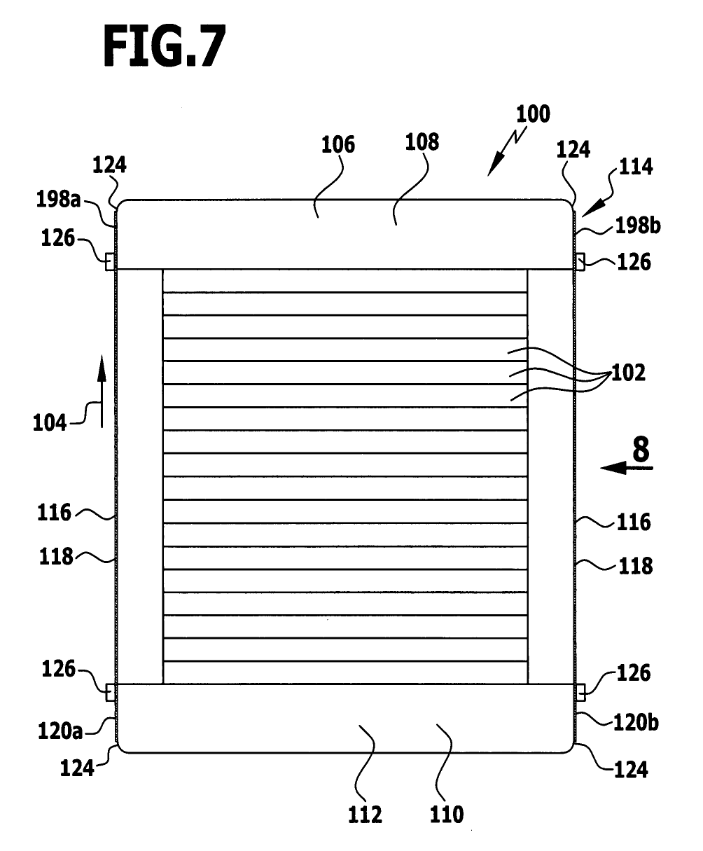

FIG. 7 a schematic front view of a fourth embodiment of a fuel cell stack which comprises four tensioning tapes which are each hooked onto the two end plates; and

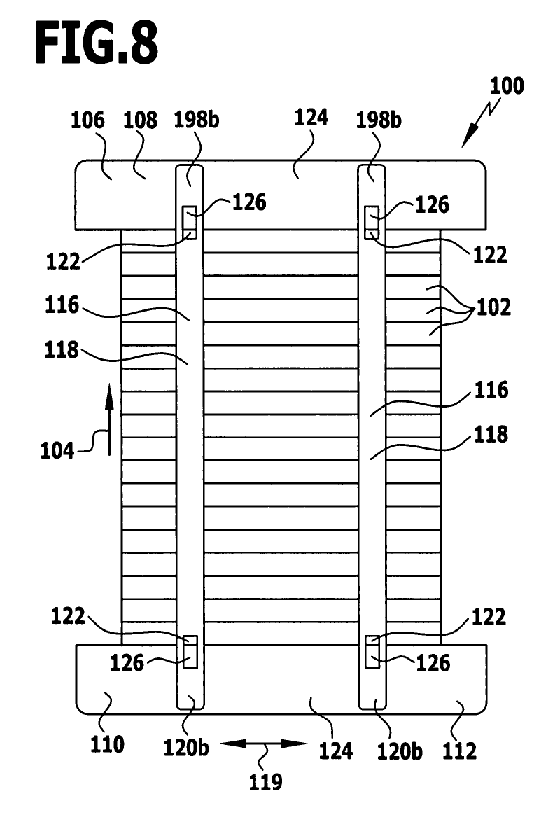

FIG. 8 a schematic side view of the fuel cell stack in FIG. 7 along the line of sight in the direction of the arrow 8 in FIG. 7.

Similar or functionally equivalent elements are designated by the same reference symbols in each of the Figures.

A fuel cell stack bearing the general reference 100 which is illustrated in FIGS. 1 to 4 comprises a multiplicity of planar fuel cell units 102 which are stacked on top of one another in the direction of the stack 104.

Each of the fuel cell units 102 comprises a (not illustrated in detail) housing which, for example, may be composed of a first sheet metal shaped part in the form of an upper housing part and a second sheet metal shaped part in the form of a lower housing part such as is described and illustrated in DE 100 44 703 A1 for example.

Each of the fuel cell units 102 is provided with passage openings for a fuel gas and with passage openings for an oxidizing agent, wherein the passage openings of successive fuel cell units 102 in the direction of the stack 104 are aligned with one another in such a manner that supply channels for the fuel gas and for the oxidizing agent as well as channels for surplus fuel gas and surplus oxidizing agent are formed through the fuel cell stack 100.

A substrate having a cathode electrolyte anode unit (CEA unit) arranged thereon is held on the housing of each fuel cell unit 102, whereby the electro-chemical fuel cell reaction takes place in the CEA unit.

The CEA units of neighbouring fuel cell units 102 are connected to one another by electrically conductive contact elements.

The housings of successive fuel cell units 102 are connected to one another by means of electrically insulating, gas-tight seal elements.

The upper end face of the fuel cell stack 100 is bounded by a first stack end element 106 in the form of an upper end plate 108.

The lower end face of the fuel cell stack 100 is bounded by a second stack end element 110 in the form of a lower end plate 112.

The end plates 108, 112 have a larger horizontal cross section than the fuel cell units 102 and project laterally beyond the stacked fuel cell units 102.

The end plates 108, 112 are preferably made of a metallic material which is chemically and mechanically stable at the operating temperature of the fuel cell units 102 and may comprise gas passage channels that are connected to the supply channels and the exhaust channels for the fuel gas and the oxidizing agent which extend through the fuel cell units 102.

Furthermore, in order to apply the requisite sealing forces to the seal elements of the fuel cell units 102 and the requisite contact forces to the contact elements of the fuel cell units 102 during operation of the fuel cell stack 100, the fuel cell stack 100 comprises a tensioning device 114 by means of which the stack end elements 106, 110 and thus the fuel cell units 102 arranged therebetween are braced against each other.

In the case of the embodiment of a fuel cell stack 100 illustrated in FIGS. 1 to 4, this tensioning device 114 comprises a plurality of, two for example, tape-like tensioning elements 116 in the form of tensioning tapes 118 which extend around one of the stack end elements 106, 110, around the upper end plate 108 for example, and the two end regions 120a, 120b thereof are hooked onto the respective other stack end element, thus, for example, on the lower end plate 112.

In order to enable this hooking process to be effected, the end regions 120a, 120b of the tensioning tapes 118 are provided with a respective, rectangular for example, hooking opening 122, whilst the side walls 124 of the lower end plate 112 are provided with a plurality of hooking noses 126 which comprise a downwardly protruding projection 128.

When hooking the tensioning tapes 118 on the fuel cell stack 100, the end regions 120a, 120b of the tensioning tapes are pulled down to such an extent that the projections 128 of the hooking noses 126 of the lower end plate 112 can be moved through the hooking openings 122 in the tensioning tapes 118 and the lower edges of the hooking openings 122 then come to rest behind the respective projections 128 forming an under-cut after they have been pulled upwardly again due to the self-elasticity of the respective tensioning tape 118 and in consequence they are prevented from being detached from the lower end plate 112 by the projections 128.

The connection between a tensioning tape 118 and the lower end plate 112 can be released in a simple manner in that the end region 120a, 120b of the tensioning tape 118 is pulled downwardly until the respective hooking opening 122 is aligned with the hooking nose 126 in such a way that the edge of the hooking opening 122 can be moved away from the side wall 124 of the lower end plate 112 past the hooking nose 126 so as to disengage the tensioning tape 118 from the hooking nose 126.

The two tensioning tapes 118 are spaced from each other in a horizontal transverse direction 119 running perpendicularly to the direction of the stack 104.

The tensioning tapes 118 are preferably formed from a metallic material, and in particular, from a material consisting of a steel sheet.

As an alternative thereto, other materials having a sufficiently high tensile strength and thermal stability could also be used, such as suitable synthetic materials for example.

If the temperature of the fuel cell stack 100 changes and in particular is brought up to the operating temperature, the fuel cell units 102 together with the stack end elements 106 and 110 on the one hand and the tensioning elements 116 on the other may expand in the direction of the stack 104 by different amounts due to their different average coefficients of thermal expansion. In order to be able to compensate for such different longitudinal expansions but nevertheless produce a sufficiently high contacting force and sealing force between the fuel cell units 102 by means of the tensioning device 114, each of the tensioning elements 116 comprises two resilient longitudinal expansion compensating elements 130 which are integrated into the two sections 134a, 134b of the respective tensioning tape 118 running in parallel with the direction of the stack 104 in the form of concertina-like folded or corrugated regions 132.

If the fuel cell units 102 expand in the direction of the stack 104 to a greater extent than the material of the tensioning tapes 118, then the expansion of the folded or corrugated regions 132 in the direction of the stack 104 increases by an amount corresponding to the difference in the longitudinal expansion in that the apex lines 136 of the folded or corrugated region 132 move further apart.

Conversely, shortening of the folded or corrugated region 132 in the direction of the stack 104 is obtained by virtue of the apex lines 136 of the folded or corrugated region 132 being moved closer together.

In consequence, a difference in the thermal expansion of the fuel cell units 102 on the one hand and the material of the tensioning elements 116 on the other can be balanced out, overstretching of the tensioning elements 116 can be prevented and a desired tensioning force effective on the fuel cell units 102 can be maintained by a reversible variation in the length of the longitudinal expansion compensating elements 130.

The section 138 of each tensioning tape 118 that is arranged between the sections 134a, 134b which run parallel to the direction of the stack 104 and rest in flat manner against the side walls 124 of the upper end plate 108 is itself disposed in flat manner on the upper surface of the upper end plate 108 so that the tensional force of the tensioning elements 116 is then effective over a large surface area and is evenly distributed over the upper end plate 108, this thereby ensuring a uniform flow of force through the upper end plate 108 to the fuel cell units 102.

A second embodiment of a fuel cell stack 100 that is illustrated in FIG. 5 differs from the previously described first embodiment in that the first stack end element 106, i.e. the upper end plate 108, does not rest directly on the uppermost fuel cell unit 102, but rather, rests indirectly thereon via a plurality of resilient pressure transmission elements 138 which are arranged between the first stack end element 106 and the uppermost fuel cell unit 102.

For the purposes of seating these pressure transmission elements 138, the upper end plate 108 of the fuel cell stack 100 is provided on the lower surface thereof with a substantially cuboidal recess 140.

The resilient pressure transmission elements 138 may, in particular, be in the form of metal sheets which are each provided with a full corrugation 141 and are arranged on one another in pairs in such a manner that the crests 142 of the full corrugations 141 face one another and the feet 144 thereof are supported on the upper end plate 108 or on the uppermost fuel cell unit 102.

By using such additional resilient pressure transmission elements 138, the flow of force between the fuel cell units 102 on the one hand and the tensioning elements 116 and the stack end element 106 on the other can be controlled in an even more precise and equalised manner.

In all other respects, the second embodiment of a fuel cell stack 100 that is illustrated in FIG. 5 agrees in regard to the construction and functioning thereof with the first embodiment illustrated in FIGS. 1 to 4 and to this extent reference is made to the preceding description thereof.

A third embodiment of a fuel cell stack 100 that is illustrated in FIG. 6 differs from the first embodiment illustrated in FIGS. 1 to 4 in that thermal insulation 146 is arranged between the fuel cell units 102 and the tensioning device 114, this comprising end plates 108, 112 that are formed of a heat insulating material or incorporate heat insulating inserts as well as thermal insulation elements 148 laterally covering the fuel cell units 102.

The thermal insulation 146 is capable of transmitting forces from the tensioning elements 116 to the fuel cell units 102.

Furthermore, the thermal insulation 146 enables the fuel cell units 102 to be operated at an operating temperature which is significantly above the ambient temperature.

The third embodiment of a fuel cell stack 100 that is illustrated in FIG. 6 is therefore suitable, in particular, for use with high temperature fuel cell units which have an operating temperature in a range of approximately 800° C. to approximately 950° C.

Such high temperature fuel cell units may, in particular, be of the SOFC (Solid Oxide Fuel Cell) type.

In all other respects, the third embodiment of a fuel cell stack 100 that is illustrated in FIG. 6 agrees in regard to the construction and functioning thereof with the first embodiment illustrated in FIGS. 1 to 4 and to this extent reference is made to the preceding description thereof.

A fourth embodiment of a fuel cell stack 100 that is illustrated in FIGS. 7 and 8 differs from the first embodiment illustrated in FIGS. 1 to 4 in that instead of two tape-like tensioning elements 116 which extend around the upper end plate 108, there are provided four tape-like tensioning elements 116 in the form of tensioning tapes 118 which are each hooked onto both the lower end plate 112 and on the upper end plate 108.

In order to achieve this effect, the upper end plate 108 also comprises hooking noses 126 on the side walls 124 thereof, these said noses being mirror-symmetrical with respect to the hooking noses 126 on the lower end plate 112.

Furthermore, the upper end regions 198a and 198b of the four tensioning tapes 118 are each provided with a hooking opening 122 of rectangular shape for example.

The process of hooking the tensioning tapes 118 on the hooking noses 126 of the upper end plate 108 and also that of releasing the tensioning tapes 118 from the hooking noses 126 takes place in exactly the same way as was described hereinbefore in connection with the first exemplary embodiment for the process of hooking them on the hooking noses 126 of the lower end plate 112 and that of releasing the tensioning tapes 118 from the lower end plate 112

In all other respects, the fourth embodiment of a fuel cell stack 100 that is illustrated in FIGS. 7 and 8 agrees in regard to the construction and functioning thereof with the first embodiment illustrated in FIGS. 1 to 4 and to this extent reference is made to the preceding description thereof.

1. A fuel cell stack comprising a plurality of fuel cell units that succeed one another in the direction of the stack, at least one tensioning device by means of which the fuel cell units are braced against each other, and at least one stack end element which forms an end face boundary for the fuel cell stack,
wherein the tensioning device comprises at least one tensioning element which transmits a tensional force for the tensioning of the fuel cell units and is hooked onto at least one stack end element.

2. A fuel cell stack in accordance with claim 1, wherein at least one stack end element comprises at least one hooking nose for the purposes of hooking on the at least one tensioning element.

3. A fuel cell stack in accordance with claim 2, wherein the hooking nose comprises a projection forming an under-cut by means of which the tensioning element is prevented from being removed from the stack end element.

4. A fuel cell stack in accordance with claim 1, wherein at least one tensioning element comprises at least one hooking opening for the purposes of hooking it onto at least one stack end element.

5. A fuel cell stack in accordance with claim 1, wherein the fuel cell stack comprises two mutually opposed stack end elements which form a respective end face boundary for the fuel cell stack, and wherein at least one tensioning element is hooked onto the two stack end elements.

6. A fuel cell stack in accordance with claim 1, wherein at least one tensioning element is in the form of a strip or tape.

7. A fuel cell stack in accordance with claim 1, wherein at least one tensioning element extends around at least one end face of the fuel cell stack.

8. A fuel cell stack in accordance with claim 1, wherein the tensioning device comprises at least two tensioning elements which extend around at least one end face of the fuel cell stack and are mutually spaced in a direction running transverse to the direction of the stack.

9. A fuel cell stack in accordance with claim 1, wherein at least one stack end element is in the form of an end plate.

10. A fuel cell stack in accordance with claim 1, wherein at least one tensioning element extends around at least one stack end element of the fuel cell stack.

11. A fuel cell stack in accordance with claim 10, wherein the tensioning element extending around at least one stack end element of the fuel cell stack is hooked onto another stack end element of the fuel cell stack.

12. A fuel cell stack in accordance with claim 10, wherein at least one tensioning element rests on at least one stack end element.

13. A fuel cell stack in accordance with claim 12, wherein at least one tensioning element rests in substantially flat manner on at least one stack end element.

14. A fuel cell stack in accordance with claim 1, wherein the tensioning device comprises at least one resilient longitudinal expansion compensating element.

15. A fuel cell stack in accordance with claim 14, wherein at least one longitudinal expansion compensating element is integrated into at least one tensioning element.

16. A fuel cell stack in accordance with claim 15, wherein at least one longitudinal expansion compensating element is formed by a corrugated and/or folded region of at least one tensioning element.

17. A fuel cell stack in accordance with claim 15, wherein at least one longitudinal expansion compensating element is formed by a region of at least one tensioning element that is provided with a deformable recess.

18. A fuel cell stack in accordance with claim 1, wherein the fuel cell stack comprises at least one resilient pressure transmission element.

19. A fuel cell stack in accordance with claim 18, wherein at least one pressure transmission element is arranged between a fuel cell unit and a stack end element which forms an end face boundary for the fuel cell stack.

20. A fuel cell stack in accordance with claim 1, wherein the fuel cell stack comprises at least one thermal insulation element.

21. A fuel cell stack in accordance with claim 20, wherein at least one thermal insulation element is arranged between the fuel cell units and at least one tensioning element.
